(19) United States
(12) Patent Application Publication
(10) Pub. No.: US 2025/0346075 A1
(43) Pub. Date: Nov. 13, 2025

(54) SYSTEM FOR STATUS MONITORING AND AXLE SYSTEM

(71) Applicant: SAF-HOLLAND GmbH, Bessenbach (DE)

(72) Inventor: Tobias Zeis, Bessenbach (DE)

(21) Appl. No.: 18/866,741

(22) PCT Filed: Sep. 6, 2023
(86) PCT No.: PCT/EP2023/074444

§ 371 Date: Nov. 18, 2024

(30) Foreign Application Priority Data
Sep. 16, 2022 (DE) 10 2022 123 740.0

(51) Int. Cl. B60C 23/00; B60C 23/04

(52) U.S. Cl. CPC B60C 23/00336; B60C 23/0422

(57) ABSTRACT

An axle system and a condition monitoring system, having an axle end with a receiving region configured as a recess, wherein a measuring unit is arranged in the receiving region stationary relative to the axle end and fixed, wherein the measuring unit has an evaluation unit to which a plurality of sensors are connected, wherein at least one of the sensors is fixed at a distance from the evaluation unit at or in the axle end to measure local condition information of the axle end and to transmit it to the evaluation unit, wherein the evaluation unit is configured to process the local condition values and to calculate information on the condition of the axle end, wherein the measuring unit has a transmission module which is configured to transmit the information on the condition of the axle end to a central unit of the vehicle by wireless data transmission.

### BACKGROUND

The present invention relates to a system for condition monitoring in an axle system and an axle system for use in a commercial vehicle.

Measuring systems are already known from the prior art which can be used to monitor the condition data, in particular temperature and vibrations, in axle systems, in particular axle systems of commercial vehicles. The aim of these systems is to use the measured condition data to obtain information on wear or other functionally relevant characteristics of an axle system, in particular the moving parts of the axle system, and if necessary to issue warnings which inform the driver of the commercial vehicle and other persons who have access to the telemetry data and/or warning states that a critical condition has been reached. However, it has been shown that the condition monitoring systems known from the prior art can only be integrated into the axle system with great effort. The condition monitoring systems known from the prior art have also proved to be susceptible to faults themselves, as the known condition monitoring systems tend to fail, in particular in the event of severe physical damage, which can trigger a cable break, for example.

The object of the present invention is therefore to provide a particularly easy to integrate and particularly fail-safe condition monitoring system and an axle system equipped with such a condition monitoring system.

### SUMMARY OF THE INVENTION

According to the invention, an axle system is provided, in particular for use in a commercial vehicle, which has an axle end with a receiving region designed as a recess, wherein a measuring unit is arranged in the receiving region essentially stationary relative to the axle end and can be fixed or secured, wherein the measuring unit has an evaluation unit to which a plurality of sensors are connected, wherein at least one of the sensors is fixed and designed at a distance from the evaluation unit at or in the axle end, measuring local condition information of the axle end and transmitting it to the evaluation unit, wherein the evaluation unit is designed to process the local condition values and calculate information on the condition of the axle end, wherein the measuring unit has a transmission module which is designed to transmit the information on the condition of the axle end to a central unit of the commercial vehicle by wireless data transmission. In the context of the present invention, an elastic mounting, for example by means of rubber elements, is preferably regarded as an essentially stationary fixing of the measuring unit in the receiving region. In this context, the measuring unit should be fixed at the axle end, but at the same time it should be possible to compensate for shocks and vibrations by slight, elastically resilient relative movements between the axle end and the measuring unit. The measuring unit is advantageously an integrally designed system with a housing in which an evaluation unit and a transmission module are arranged, wherein the housing surrounds the two units in a protective manner and ensures that the measuring unit is fixed in the receiving region of the axle end. A large number of sensors are connected to the evaluation unit of the measuring unit, wherein the sensors themselves are arranged at a distance from the measuring unit at or in the axle end and are fixed there. The sensors can be connected to the evaluation unit via wired or wireless signal transmission means. Preferably, the sensors are distributed and spaced apart from each other at the axle end and connected to the evaluation unit located centrally in the receiving region. This allows different areas of the axle end to be monitored, for example contact areas of roller bearings or connection areas of brake systems. A cable-connected fixing of the sensors is advantageous in the context of the present invention, as the evaluation unit is also arranged within the axle end for this purpose and therefore particularly close to the measuring points to be monitored in the axle end. Preferred mounting positions for the sensors in the axle end are, for example, at the level of the roller bearings, which allows the temperature in this area to be determined and thus conclusions to be drawn about the state of wear or any malfunctions of the bearings. Preferably, the evaluation unit can also have one or more sensors arranged directly on it, for example to monitor vibrations or temperatures of the measuring unit itself. Preferably, in addition or as an alternative to the sensors designed as temperature sensors or vibration sensors, at least one wear sensor can be provided, which directly measures wear in the area of certain functional surfaces of the axle end or adjacent components. Furthermore, the sensors can include at least one strain gauge, which is fixed to the axle end in such a way that bending of the axle end can be detected. This allows conclusions to be drawn about the load condition of the axle and the commercial vehicle. In the context of the present invention, the axle end itself is advantageously a stub axle, which is provided with a bore that serves as a receiving region for the measuring unit. The bore in the stub axle is advantageously a face bore in which the measuring unit, at least the evaluation unit component of the measuring unit, is inserted and is advantageously elastically fixed there, for example by means of a circlip or internal retaining ring. Advantageously, at least the evaluation unit of the measuring unit is arranged and fixed in this bore, wherein the other components, such as the transmission module, can also be arranged outside the bore. As an alternative or in addition to the arrangement of a measuring unit on the stub axle, it may be provided within the scope of the present invention to arrange a measuring unit, for example, in the rotating hub of the commercial vehicle, wherein the wireless transmission of the information of the measuring unit allows such an arrangement in the rotating part of the wheel suspension without further ado. A transmission module is connected to the evaluation unit, which is designed in particular for wireless transmission of the information collected by the evaluation unit to a central unit of the commercial vehicle. Such a central unit of the commercial vehicle is advantageously a central telemetry unit which, in addition to the values transmitted by the measuring unit, also collects and processes other condition values of the commercial vehicle and makes them available to the vehicle driver and other subsystems of the commercial vehicle. The CAN bus system of the commercial vehicle could also function as a central unit, wherein such CAN bus systems are already known from the prior art. The transmission module is therefore designed to send the information on the condition of the axle end in a format adapted for the corresponding central unit or a corresponding transmission protocol. The advantage of wireless transmission of condition information from the measuring unit to a central unit of the commercial vehicle is that the measuring unit can be arranged as close as possible to the sensors used, while no complex cabling is required to connect the measuring unit to the data processing systems arranged centrally on the commercial vehicle. This increases the operational reliability of condition monitoring in particular, as only the short cabling between the measuring unit and the sensors is required, which can essentially be arranged within a component and therefore does not have to compensate for relative movements between different components. This reduces the risk of cable breaks. Furthermore, the measuring unit together with the sensors forms an assembly, wherein a large number of such assemblies can be arranged on the commercial vehicle and in particular on the trailer of a commercial vehicle without major assembly work, which enables particularly comprehensive monitoring of the condition data on the entire commercial vehicle.

In a preferred embodiment, the measuring unit has a voltage source which comprises an energy storage unit and/or a voltage generator, wherein the voltage source is preferably independent of the power supply of the commercial vehicle. The advantages of the measuring unit being wirelessly connected to a central unit are particularly apparent if the measuring unit has its own energy storage unit and/or its own voltage generator. In the present case, the preferred energy storage unit is a battery whose capacity is designed in such a way that it can be replaced within the usual service intervals of a commercial vehicle, for example once a year, and enables continuous operation of the measuring unit over this period. A voltage generator that generates an electrical voltage from the relative movements of various components of the axle system, which is used to operate the measuring unit, is particularly suitable as a voltage generator.

Advantageously, the voltage generator comprises at least one coil which is arranged essentially stationary relative to the axle end and in particular to the measuring unit, wherein the axle system has a rotor which is mounted on the axle end so as to be rotatable about an axis of rotation, wherein an exciter is provided which is set in rotation by the rotor in order to generate an inductive voltage in the voltage generator, wherein the exciter is formed integrally on the rotor, or is connected to the rotor in a form-fitting or material-fitting manner, or is magnetically coupled to the rotor. The embodiment described here relates in particular to the case where the axle end is a stub axle around which the hub of a wheel suspension of a commercial vehicle is rotatably arranged. It is understood that if the measuring unit is arranged in the hub of the commercial vehicle, the stub axle on which this hub is rotatably mounted is regarded as the part of the axle suspension that rotates relative to the hub. The decisive criterion for the preferred embodiment of the invention is that the coil, in which a voltage is generated, is advantageously arranged in a fixed position relative to the measuring unit, with the exciter of this voltage performing a relative movement relative to the coil.

In a particularly preferred embodiment, the exciter has a large number of permanent magnets. These permanent magnets are advantageously positively and/or materially fixed to the rotor, i.e. to the component of the axle suspension rotating relative to the measuring unit. In a first preferred embodiment, the permanent magnets can be fixed in the area of the hub, in particular preferably in the area of the cover, which covers the recess of the hub to reach the axle nut, at least with a material connection. This arrangement of permanent magnets on the rotating part of the wheel suspension of the commercial vehicle is possible with particularly minor design interventions, which makes it possible to retrofit a measuring unit with a corresponding power supply even on older commercial vehicles. As an alternative to the arrangement of permanent magnets on the exciter, the exciter can also have a large number of block-like projections and recesses, wherein these generate a Hall voltage in a voltage generator arranged in the corresponding vicinity. Particularly in the case of a measuring unit which only has a very low energy requirement, it may be sufficient to use such a Hall voltage generator which is very simple to manufacture.

Furthermore, the exciter is preferably stationary and rotatably mounted at the axle end and/or on the voltage source, wherein the exciter can be set in rotation by the rotor by means of mechanical or magnetic coupling. In this embodiment, the exciter is thus designed as part of the measuring unit, wherein the exciter itself is fixed to the rest of the measuring unit so that it can rotate with respect to the latter and is secured against transverse displacement. This embodiment makes it possible to integrate a self-sufficient measuring unit with even less design intervention in the overall construction of a wheel suspension of the commercial vehicle. Only a mechanical or magnetic drive of the exciter by the part of the axle suspension of the commercial vehicle that rotates relative to the measuring unit is required. In a first preferred embodiment, a positive-locking power transmission, such as achieved by toothing, can be provided between a drive element of the exciter and, for example, the wheel hub of the axle suspension of the commercial vehicle. In an alternative embodiment, a magnet or a plurality of magnets can be provided on the exciter, each of which interacts with local projections on the rotor of the axle suspension of the commercial vehicle in such a way that rotation of the rotor causes rotation of the exciter.

As an alternative or in addition to a voltage generator driven by rotational movement, the voltage source preferably has a voltage generator which comprises an electronic linear generator, wherein the voltage generator is designed to generate an electrical voltage from essentially linear movements of an oscillating spring-mass system. The advantage of a voltage generator based on linear movement is that it can convert shocks and vibrations on the chassis of the vehicle into electrical voltage. This can allow a targeted voltage supply to the measuring unit, particularly in the presence of critical load conditions on the chassis on uneven ground, which are to be detected by the sensors of the condition monitoring system. In this context, an essentially linear movement is considered to be a compression or rebound movement of a wheel suspension, which more precisely describes an arc of a circle, as the axle end is usually arranged via a link that is fixed to the chassis frame so that it can pivot about a pivot point.

In particular, a pressure monitoring system is preferably provided on the axle system, wherein the measuring unit has a recess through which a pressure line of the pressure monitoring system passes, wherein the pressure line is preferably supported in the recess. In order to enable the measuring unit to be used on axle systems on which monitoring is also present, it is preferred that it has a recess through which a pressure line of the pressure monitoring system can pass. It is particularly preferred that this pressure line is also supported in the recess of the measuring unit, which allows a particularly stable and compact design of an axle system with condition monitoring and additional pressure monitoring. The Tire Pilot system is known as an example of a tire pressure monitoring system, which can therefore be combined particularly preferably with a measuring unit according to the present invention. In the interaction of a pressure monitoring system with a measuring unit according to the present invention, it can be particularly advantageous for the exciter to be arranged on the rotating part of the pressure monitoring system.

The receiving region is advantageously designed as an essentially cylindrical recess or cut-out or bore in an end region of the axle end, wherein the measuring unit is fixed directly or indirectly in the receiving region. A direct fixing of the measuring unit in the receiving region is advantageously achieved by a slight clearance fit of the measuring unit in the receiving region, in which the measuring unit can merely be pushed into the receiving region and clamped there and/or secured by a circlip, for example. Alternatively, the measuring unit can be screwed into the receiving region via an external thread formed on it. Indirect fixing is considered to be fixing via additional fastening means, such as screws, which transmit a force between the measuring unit and the receiving region to fix the measuring unit. Furthermore, for example, elastically deformable bearing elements can be provided between the cylindrical recess of the receiving region, which in turn elastically support the outside of the measuring unit in relation to the recess of the receiving region. In the context of the present invention, an essentially cylindrical recess is defined as an inner surface which has a cylindrical inner geometry at least in the area of contact with the measuring unit or with bearing elements arranged therebetween.

In a particularly preferred embodiment, the measuring unit has an external thread which can be brought into engagement with a corresponding internal thread in the receiving region in order to secure the measuring unit at the axle end. This particularly simple way of securing the measuring unit in the receiving region makes it possible to screw the measuring unit into the recess with internal thread in the receiving region without any further aids. It is particularly preferred that the measuring unit has an engagement area at its end opposite the thread at which a corresponding torque can be transmitted to the housing of the measuring unit. Furthermore, it is preferred that the thread and the engagement means for torque transmission are arranged on the housing of the measuring unit in such a way that the housing is designed to be rotatable relative to the evaluation unit so that the evaluation unit is not rotated together with the housing when the measuring unit is screwed in and the cables to the sensors do not twist or tangle.

In a further preferred embodiment, the measuring unit is held in the receiving region by means of elastic bearing elements, wherein the bearing elements are designed for vibration damping. It is particularly advantageous to mount the measuring unit in the receiving region using a series of elastic and vibration-damping bearing elements, in particular preferably to clamp it. In addition to the mounting by the bearing elements, a positive and/or non-positive connection can also be provided between the measuring unit and the axle end. The bearing elements used are preferably ring-shaped or, for example, block-shaped rubber elements, which are preferably fixed in the receiving region and/or on the measuring unit with a material connection. The vibration-damped bearing of the measuring unit can increase its service life, in particular the service life of the evaluation unit and the transmission module.

According to the invention, a condition monitoring system is also provided, which has a measuring unit with a voltage source, wherein a plurality of sensors are connected to the measuring unit, which are preferably designed as temperature sensors, wherein the voltage source has a voltage generator which is designed to provide an inductively generated voltage, wherein the measuring unit has an evaluation unit which is designed to interpret the values measured by the sensors, wherein the measuring unit has a transmission module which is designed to send the determined condition values wirelessly. The features of the measuring unit, with the integrated voltage source and transmission unit, correspond to the previously described features of a measuring unit installed in an axle system. In addition to use at the axle end of an axle system, this measuring unit can preferably also be used in other areas of a commercial vehicle. The voltage generator of the measuring unit advantageously uses the relative movements or rotation of two component groups to each other in order to generate a voltage, preferably inductive, which supplies the measuring unit and in particular the evaluation unit and the transmission module with sufficient electrical energy. While the sensors are preferably connected to the evaluation unit via cables as described above, the transmission module is designed for wireless information transmission, in particular preferably by radio or optical signal transmission, such as laser pulses.

The measuring unit has a particularly preferred circular cross-section. The circular cross-section of the measuring unit makes it possible to insert the measuring unit with its cylindrical outer geometry into the axle end of an axle system. Furthermore, the cylindrical opening within the measuring unit allows a pressure monitoring system to be guided through the measuring unit and supported in it. This makes it possible to simultaneously monitor the condition and tire pressure of the axle system and thus significantly increase its service life. The measured condition values, in combination with the tire pressure monitoring values, can also provide more reliable conclusions about the actual wear or other problems on the axle system.

The combination of the two monitoring systems thus enables the best possible compliance with preferred operating conditions on the axle system, which can significantly increase the service life of the axle system.

In particular, the measuring unit preferably has a plurality of bearing elements which are designed to be fixed in a receiving region of an axle end and/or which are designed to bear a pressure monitoring system inside the measuring unit. The bearing elements are thus preferably provided on the outside of the measuring unit for support in the receiving region of an axle end. Furthermore, the bearing elements, which are advantageously elastic, are also arranged on the inside, preferably in the opening of the measuring unit to accommodate a pressure line of a monitoring system. The bearing elements make a significant contribution to both the bearing of the measuring unit and the elastically sprung support of the pressure monitoring system in order to increase the service life and resistance of the condition monitoring system.

### BRIEF DESCRIPTION OF THE DRAWINGS

Further advantages and features of the present invention can be seen from the following description of the attached figures. It is understood that individual features shown in only one of the figures can also be used in embodiments of other figures, unless this has been explicitly excluded or is prohibited due to technical circumstances.

It shows:

FIG. 1 is a schematic sectional view of a first preferred embodiment;

FIG. 2 is a further schematic sectional view of a second preferred embodiment;

FIG. 3 is a further schematic sectional view of a third preferred embodiment; and

FIG. 4 is a schematic view of an overall system with several condition monitoring systems according to the invention.

### DETAILED DESCRIPTION

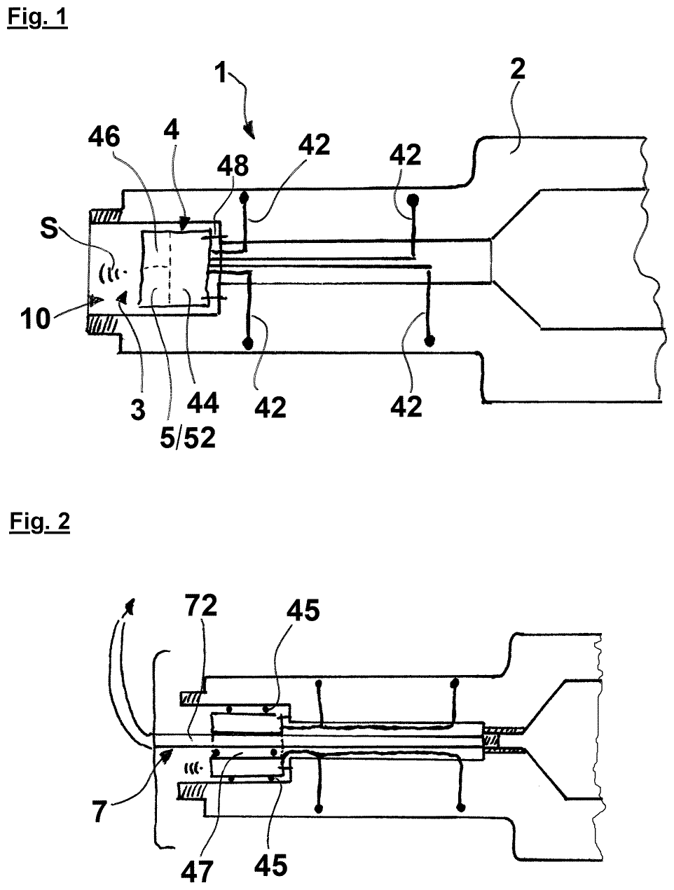

In the axle system 1 shown in FIG. 1, a receiving region 3, in which a measuring unit 4 is arranged, is formed in an axle end 2, which is advantageously designed as a stub axle. The measuring unit 4 has an evaluation unit 44, which is connected to a plurality of sensors 42, in this preferred example 4 sensors 42. It is understood that a larger number of sensors 42 can also be connected to the evaluation unit. Preferably, the sensors are arranged in the area of the bearings, which are mounted on the stub axle and for the rotatable mounting of a hub. In this way, the temperature or other condition variables can be determined in the area of contact between the bearings and the axle end. In addition to the evaluation unit 44, the measuring unit has a transmission module 46, which is designed for wireless signal transmission to a central unit (not shown) of the commercial vehicle. Furthermore, the measuring unit preferably has a voltage source 5, which in the present example has an energy storage unit 52. The energy storage unit 52 of the voltage source is advantageously particularly easy to access from the outside, in the figure correspondingly from the left, in order to make it particularly easy to change the energy storage unit. In contrast to the embodiments described below, the present measuring unit thus manages without a voltage generator, since the entire energy required to supply the evaluation unit 44 and the transmission module 46 can be taken from the energy storage unit 52. Preferably, the measuring unit 4 is fixed to the material of the axle end 2 via fastening elements 48 such a fixing is defined in the context of the present invention as indirect fastening of the measuring unit 4 to the axle end 2 via fastening elements 48. An alternatively or additionally preferred direct fastening of the measuring unit 4 within the receiving region 3 can be produced, for example, via a thread or a material-locking connection, such as via an adhesive layer between the measuring unit 4 and the receiving region 3.

The schematic view shown in FIG. 2 shows an embodiment of an axle system 1 according to the invention, in which the measuring unit 4 is essentially circular in shape and has a recess 47 through which the pressure line 72 of a pressure monitoring system 7 can be guided. In addition to the bearing elements 45 preferably arranged on the outside of the measuring unit 4, further bearing elements 45 can also be arranged in the recess 47 in order to hold and elastically support the pressure line 72 of the pressure monitoring system 7. This simple combination of condition monitoring and tire pressure monitoring in an axle end 2 designed as a hollow stub axle enables an axle system that is particularly easy to manufacture and has a long service life.

FIG. 3 shows a schematic view of a further preferred embodiment of an axle system 1 according to the invention. In contrast to the embodiments described above, the measuring unit 4 has a voltage source 5 with a voltage generator 54 and a preferably also provided energy storage unit 52. In this context, the voltage source 5 could also have only one voltage generator 54, whereby a voltage supply to the evaluation unit 44 and the transmission module 46 would only be ensured during actual use of the commercial vehicle, i.e. when the wheels are rotating. To simplify the measuring unit and in particular its power supply, this embodiment may be preferred. The advantage of combining a voltage generator 54 with an energy storage unit 52 is that the energy storage unit 52 can be relatively small, since it only has to temporarily store the energy generated by the voltage generator 54, for example to bridge downtimes of the commercial vehicle. For inductive voltage generation in the voltage generator 54, the axle system 1 preferably has a rotor 6, which is rotated relative to the measuring unit 4 together with an exciter 62. The exciter 62 advantageously comprises a plurality of permanent magnets, which interact with corresponding coils in the voltage generator 54 in order to generate an induction voltage there. Not shown here is the embodiment in which the exciter 62 is fixed to the measuring unit 4 and at the same time is mounted rotatably about an axis of rotation relative to the measuring unit 4. In this case, the exciter 62 is set in rotation via a mechanical or magnetic coupling with the rotor 6 and, as described above, generates an induction voltage in the coils of the voltage generator 54.

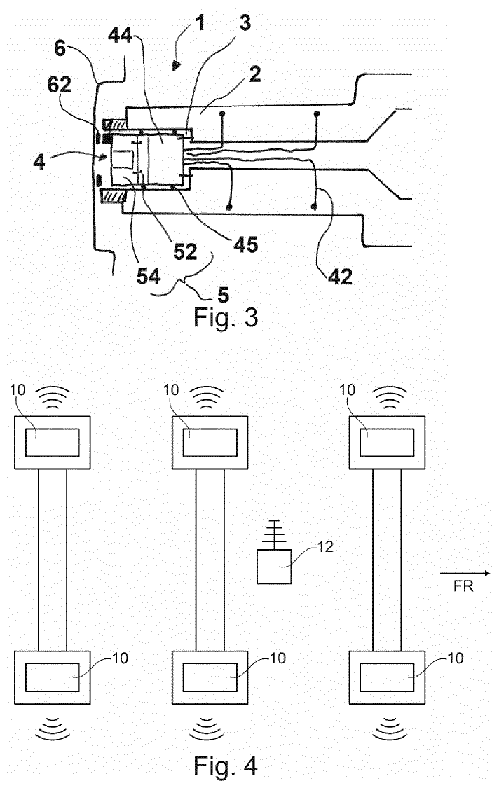

Finally, FIG. 4 shows a schematic view of an overall system of a commercial vehicle with several condition monitoring systems 10, one of which is arranged in each axle end of each axle system 1. The six condition monitoring systems 10 shown in this embodiment transmit their condition information wirelessly to the central unit 12. Such a central unit in a commercial vehicle is referred to as a “Trailer Master”, for example, and is used for centralized information procurement and processing of relevant telemetry and condition data of a commercial vehicle, in particular a commercial vehicle trailer.

### List of reference signs

1—Axle system
2—Axle end
3—Receiving region
4—Measuring unit
5—Voltage source
6—Rotor
7—Pressure monitoring system
10—Condition monitoring system
12—Central unit
42—Sensor
44—Evaluation unit
45—Bearing element
46—Transmission module
47—Recess
48—Fastening element
52—Energy storage unit
54—Voltage generator
62—Exciter
72—Pressure line

1.-15. (canceled)

16. An axle system for use in a commercial vehicle, comprising:
an axle end with a receiving region comprising a recess; and
a measuring unit is configured to be fixed in the receiving region in a substantially stationary manner relative to the axle end;
wherein the measuring unit has an evaluation unit to which a plurality of sensors are connected;
wherein at least one of the sensors of the plurality of sensors is fixed at a distance from the evaluation unit at or in the axle end and is configured to measure local condition information of the axle end and transmit the local condition information to the evaluation unit;
wherein the evaluation unit is configured to processing the local condition information and calculate information on a condition of the axle end; and
wherein the measuring unit has a transmission module which is configured to transmit the information on the condition of the axle end to a central unit of the commercial vehicle by wireless data transmission.

17. The axle system according to claim 16, wherein the measuring unit has a voltage source which comprises an energy storage and/or a voltage generator.

18. The axle system according to claim 17, wherein the voltage source is self-sufficient from a voltage supply of the commercial vehicle.

19. The axle system according to claim 17, wherein the voltage generator comprises at least one coil which is arranged substantially stationary relative to the axle end, the axle system has a rotor which is mounted on the axle end so as to be rotatable about an axis of rotation, an exciter is provided which is set in rotation by the rotor to generate an inductive voltage in the voltage generator, and wherein the exciter is integrally formed on the rotor, or is positively connected to the rotor, or is magnetically coupled to the rotor.

20. The axle system according to claim 19, wherein the exciter comprises a plurality of permanent magnets.

21. The axle system according to claim 19, wherein the exciter is mounted in a stationary and rotatable manner on the axle end and/or on the voltage source, and wherein the exciter is configured to be set in rotation by the rotor via mechanical or magnetic coupling.

22. The axle system according to claim 17, wherein the voltage source has a voltage generator comprising an electronic linear generator, and wherein the voltage generator is configured to generate an electrical voltage from substantially movements of an oscillating spring-mass system.

23. The axle system according to claim 16, wherein a pressure monitoring system is provided on the axle system, wherein the measuring unit has a recess through which a pressure line of the pressure monitoring system extends, and wherein the pressure line is supported in the recess.

24. The axle system according to claim 16, wherein the receiving region is formed as a substantially cylindrical recess or bore in an end region of the axle end, and wherein the measuring unit is directly or indirectly fixed in the receiving region.

25. The axle system according to claim 16, wherein at least the evaluation unit of the measuring unit is arranged and fixed in the bore.

26. The axle system according to claim 16, wherein the measuring unit has an external thread which can be brought into engagement with a corresponding internal thread in the receiving region to fix the measuring unit at the axle end.

27. The axle system according to claim 16, wherein the measuring unit is held in the receiving region via elastic bearing elements, and wherein the bearing elements are configured for vibration damping.

28. A condition monitoring system of an axle system, comprising:
a measuring unit with a voltage source;
wherein a plurality of sensors, configured as temperature sensors are connected to the measuring unit;
wherein the voltage source has a voltage generator which is configured to provide an inductively generated voltage;
wherein the measuring unit has an evaluation unit which is configured to interpret the values measured by the sensors; and
wherein the measuring unit has a transmission module which is configured to send the determined condition values wirelessly.

29. The condition monitoring system according to claim 28, wherein the measuring unit has a circular cross-section.

30. The condition monitoring system according to claim 28, wherein the measuring unit is arranged and fixed in a receiving region which is comprised as a face bore in an axle end configured as a stub axle.

31. The condition monitoring system according to claim 30, wherein the measuring unit comprises a plurality of bearing elements which are configured to be fixed in the receiving region of the axle end and/or which are configured to bear a pressure monitoring system inside the measuring unit.
